(19) United States
(12) Patent Application Publication
(10) Pub. No.: US 2013/0229673 A1
(43) Pub. Date: Sep. 5, 2013

(54) WIRELESS COMMUNICATION APPARATUS AND COMMUNICATION METHOD

(71) Applicant: CANON KABUSHIKI KAISHA, Tokyo (JP)

(72) Inventors: Shiro Nakayama, Yokohama-shi (JP); Taketomo Naruse, Yokohama-shi (JP)

(73) Assignee: CANON KABUSHIKI KAISHA, Tokyo (JP)

(21) Appl. No.: 13/777,651

(22) Filed: Feb. 26, 2013

(30) Foreign Application Priority Data
Mar. 5, 2012 (JP) 2012-048616

(51) Int. Cl. H04N 1/00

(52) U.S. Cl. CPC H04N 1/00103
USPC 358/1.13

(57) ABSTRACT

According to one advantageous aspect of the present invention, even if communication becomes impossible during data transfer, an apparatus with a small-capacity memory is efficiently used. To realize this, in a wireless communication apparatus including a wireless communication unit, wireless communication with a communication device is performed according to a first wireless communication method and a second wireless communication method that has a communicable range wider than that in the first wireless communication method. Then, a request for executing predetermined processing and information for performing wireless communication according to the second wireless communication method with an output destination of data obtained by executing the predetermined processing is received. Upon receiving the request, the predetermined processing is executed. Based on the received information, the data obtained by executing the predetermined processing is outputted to the output destination.

### BACKGROUND OF THE INVENTION

1. Field of the Invention

The present invention relates to a wireless communication apparatus, and a communication method.

2. Description of the Related Art

In recent years, there is known a technique in which an apparatus such as a mobile communication terminal or MFP (Multi-Function Printer) includes a short distance wireless communication unit to transmit/receive data such as an image (for example, Japanese Patent Laid-Open No. 2010-006016). There has been also proposed a technique of switching over, among a plurality of communication units, from a first communication unit to a second communication unit as needed in consideration of the communication speed and operability (for example, Japanese Patent Laid-Open No. 2007-166538).

The first communication unit is, for example, an NFC (Near Field Communication) unit as a low-speed communication unit in which it is possible to readily, uniquely identify a communication party. On the other hand, the second communication unit is, for example, a Bluetooth® or wireless LAN (WLAN) unit as a high-speed communication unit. There has been proposed a printer which improves the convenience by executing authentication processing and the like by the first communication unit, and transferring a large amount of data by the second communication unit.

The techniques disclosed in Japanese Patent Laid-Open Nos. 2010-006016 and 2007-166538, however, do not consider externally transmitting data from an apparatus such as an MFP with a small-capacity memory.

For example, when transferring image data read by a scanner of an MFP or the like to an external apparatus using the short distance wireless communication, that communication may be disabled while transmitting the image data. In this case, the MFP needs to hold the image data until connection is established again, or to discard the image data. This may spoil the user convenience, and reduce the usable area of the memory of the MFP.

### SUMMARY OF THE INVENTION

Accordingly, the present invention is conceived as a response to the above-described disadvantages of the conventional art.

For example, a wireless communication apparatus, and a communication method according to one embodiment of this invention are capable of efficiently using an apparatus with a small-capacity memory even if communication is disabled during data transfer.

According to one aspect of the present invention, there is provided a wireless communication apparatus. The apparatus comprises a wireless communication unit configured to be able to communicate with a communication device according to each of a first wireless communication method and a second wireless communication method that has a communicable range wider than that in the first communication method. The apparatus further comprises a reception unit configured to receive a request for executing predetermined processing and information for performing wireless communication according to the second wireless communication method with an output destination of data obtained by executing the predetermined processing, by performing wireless communication according to the first wireless communication with the communication device in the wireless communication unit, and an execution unit configured to execute the predetermined processing upon receiving the request. The apparatus also comprises an output unit configured to output the data obtained by executing the predetermined processing by the execution unit, to the output destination, by performing wireless communication according to the second wireless communication method with the output destination in the wireless communication unit, based on the information received by the reception unit.

According to another aspect of the present invention, there is provided a method applicable to the above-mentioned apparatus. The method comprises: wirelessly communicating with a communication device according to each of a first wireless communication method and a second wireless communication method that has a communicable range wider than that in the first wireless communication method; receiving a request for executing predetermined processing, and information for performing wireless communication according to the second wireless communication method with an output destination of data obtained by executing the predetermined processing, by performing wireless communication according to the first wireless communication with the communication device; and executing the predetermined processing upon receiving the request; and outputting the data obtained by executing the predetermined processing, to the output destination, by performing wireless communication according to the second wireless communication method with the output destination, based on the received information.

According to still another aspect of the present invention, there is provided a non-transitory computer readable storage which stores a computer program for executing the above method.

The embodiment according to the invention is particularly advantageous since it is possible to transfer image data obtained by a scanner apparatus to an information processing apparatus using high-speed WLAN. Furthermore, even if communication is interrupted while transferring the image data, the image data is transferred to an alternative apparatus such as a server apparatus, and then the information processing apparatus can acquire the image data from the server apparatus via a network.

This enables to efficiently use the scanner apparatus with a small-capacity memory.

Further features of the present invention will become apparent from the following description of exemplary embodiment(s) (with reference to the attached drawings).

### BRIEF DESCRIPTION OF THE DRAWINGS

FIG. 1 is a block diagram showing the overall configuration of a network system capable of performing short distance wireless communication according to an exemplary embodiment of the present invention.

FIG. 2 is a front view showing a mobile communication terminal.

FIGS. 3A and 3B are views each schematically showing the outer appearance of an MFP apparatus.

FIGS. 4A and 4B are block diagrams showing the concept of a passive mode in NFC communication.

FIGS. 5A and 5B are block diagrams showing the concept of an active mode in NFC communication.

FIG. 6 is a block diagram showing the arrangement of a mobile communication terminal 200.

FIG. 7 is a block diagram showing the schematic arrangement of an MFP 300.

FIG. 8 is a block diagram showing the detailed arrangement of an NFC unit.

FIG. 9 is a block diagram showing the internal structure of the non-volatile memory (flash memory) of the MFP.

FIG. 10 is a block diagram showing the internal structure of the non-volatile memory (flash memory) of the mobile communication terminal 200.

FIG. 11 is a flowchart for causing the NFC unit to operate as an initiator.

FIG. 12 is a sequence chart showing the sequence of performing data exchange in the passive mode.

FIG. 13 is a sequence chart showing the sequence of performing data exchange in the active mode.

FIG. 14 is a sequence chart showing the sequence of performing push-type communication in which the MFP takes initiative for transferring, to the mobile communication terminal, image data obtained by reading an image original using the scanner function of the MFP.

FIG. 15 is a sequence chart showing the sequence of performing pull-type communication in which the mobile communication terminal takes initiative for transferring, to itself, image data obtained by reading an image original using the scanner function of the MFP.

FIG. 16 is a flowchart illustrating processing executed by the mobile communication terminal from a time when an application of the mobile communication terminal is activated until communication with the MFP ends.

FIG. 17 is a flowchart illustrating processing executed by the MFP from a time when the mobile communication terminal is detected until communication with it ends.

FIG. 18 is a view showing an example of a screen for making settings for a scanner apparatus, which is displayed by the application of the mobile communication terminal.

FIG. 19 is a view showing an example of a screen for making detailed settings for the scanner apparatus, which is displayed by the application of the mobile communication terminal.

### DESCRIPTION OF THE EMBODIMENTS

An exemplary embodiment of the present invention will now be described in detail in accordance with the accompanying drawings. It should be noted that the relative arrangement of components and the like set forth in the embodiment do not limit the scope of the present invention unless it is specifically stated otherwise.

In this specification, the terms “print” and “printing” not only include the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans.

Also, the term “print medium” not only includes a paper sheet used in common printing apparatuses, but also broadly includes materials, such as cloth, a plastic film, a metal plate, glass, ceramics, wood, and leather, capable of accepting ink.

In the embodiment, a case in which after specifying a communication party and performing authentication by low-speed communication using a short distance wireless communication method, the communication is switched over to a high-speed communication to transmit image data will be described. More specifically, a method of performing, for a target, authentication by short distance wireless communication such as NFC (Near Field Communication) which does not require a power supply, and then switching the communication to another communication protocol to communicate image data will be explained.

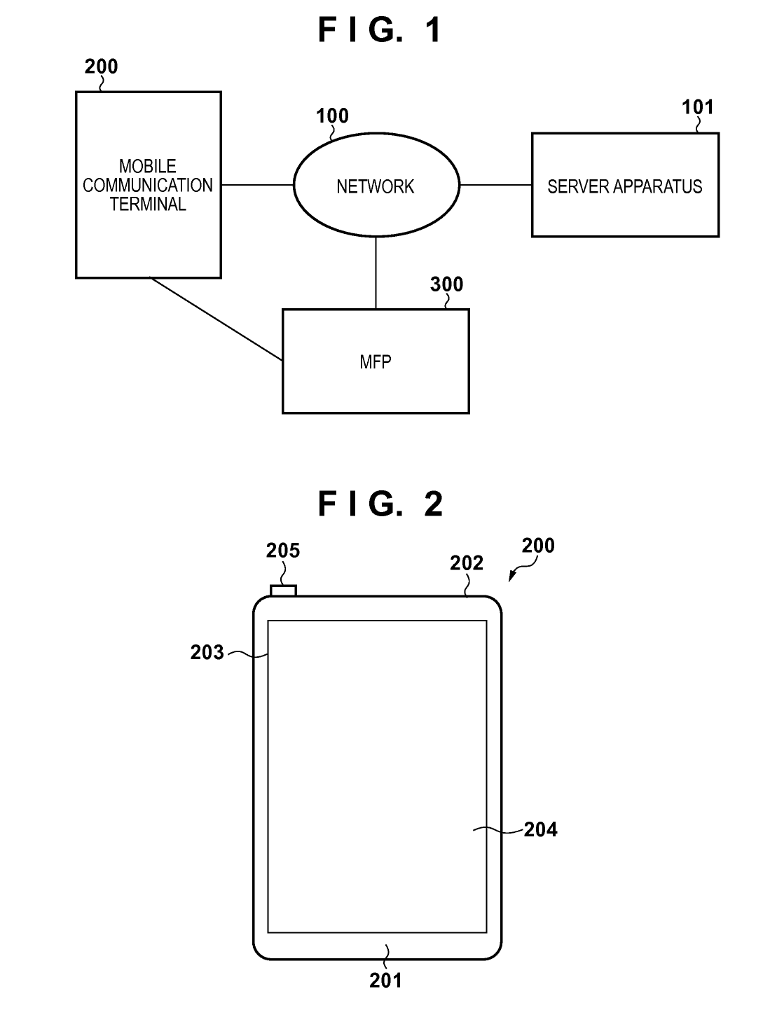

FIG. 1 is a block diagram showing the configuration of a network system using short distance wireless communication according to an exemplary embodiment of the present invention. The system has a basic configuration in which a server apparatus 101, a mobile communication terminal (information processing apparatus) 200, and a multi-function printer (to be referred to as an MFP or printing apparatus hereinafter) 300 are connected to each other via a network 100.

The server apparatus 101 includes a storage unit for image data to be printed, and a processor for managing user IDs and executing an image processing application. The mobile communication terminal 200 implements at least two types of wireless communication protocols with different authentication methods and different communication speeds. The mobile communication terminal need only be an apparatus capable of handling files of print targets, for example, a personal information terminal such as a PDA (Personal Digital Assistant), a mobile phone, a smart phone, or a digital camera. The MFP 300 is a multi-function printer including a display unit and operation panel through which various settings can be made, and having a printer function of using an inkjet printer or the like as a printer engine, a scanner function of reading an original placed on a document table, a FAX function, and a telephone function.

The network 100 and server apparatus 101 are connected by wired LAN, and the network 100 and MFP 300 are connected by wired LAN or wireless LAN (to be referred to as WLAN hereinafter). The network 100 and mobile communication terminal 200 are connected by WLAN. Since both the mobile communication terminal 200 and the MFP 300 have a WLAN function, they can perform peer to peer (to be referred to as P2P hereinafter) communication by authenticating each other.

FIG. 2 is a front view showing the mobile communication terminal 200 such as a smart phone. The smart phone indicates a multi-function mobile phone including a camera, network browser, and mail function in addition to a mobile phone function.

Referring to FIG. 2, an NFC unit 201 performs communication using NFC. Actually, communication can be performed when the user moves the NFC unit 201 close to within about 10 cm of the NFC unit of the other communication party. A WLAN unit 202 is used to perform communication using WLAN, and is arranged within the terminal. Note that the coverage of WLAN is wider than that (about 10 cm) of NFC. A display unit 203 is formed from an LCD display on which an operation unit 204 with an electrostatic touch-panel operation mechanism is arranged. The operation unit 204 detects user operation information. As a typical operation method, the display unit 203 displays button-shaped menus, and when the user touches the operation unit 204, an event associated with the button portion is issued to execute processing. A power key 205 is used to turn on/off the power.

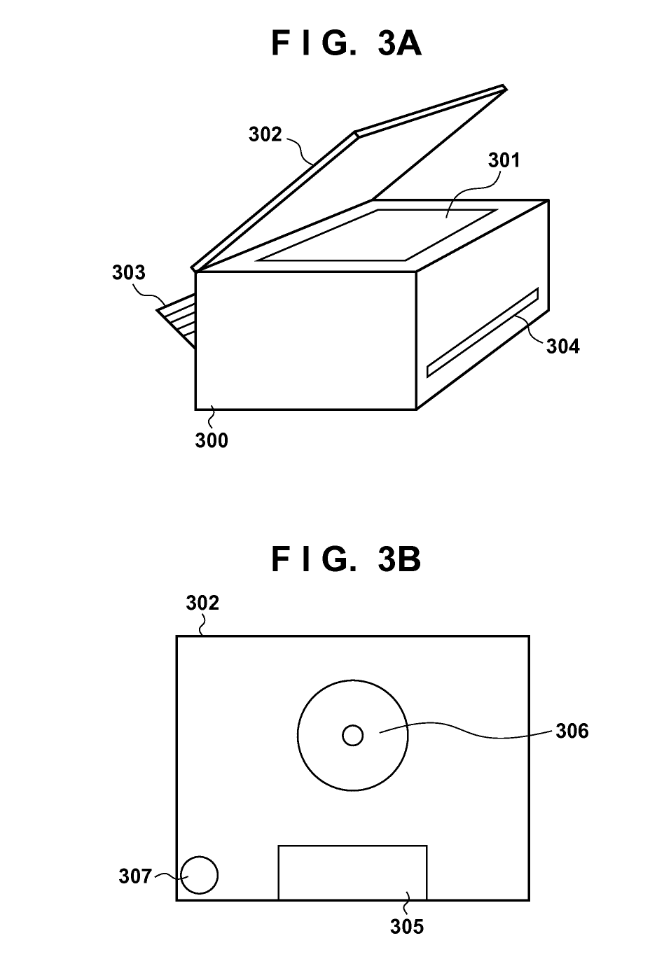

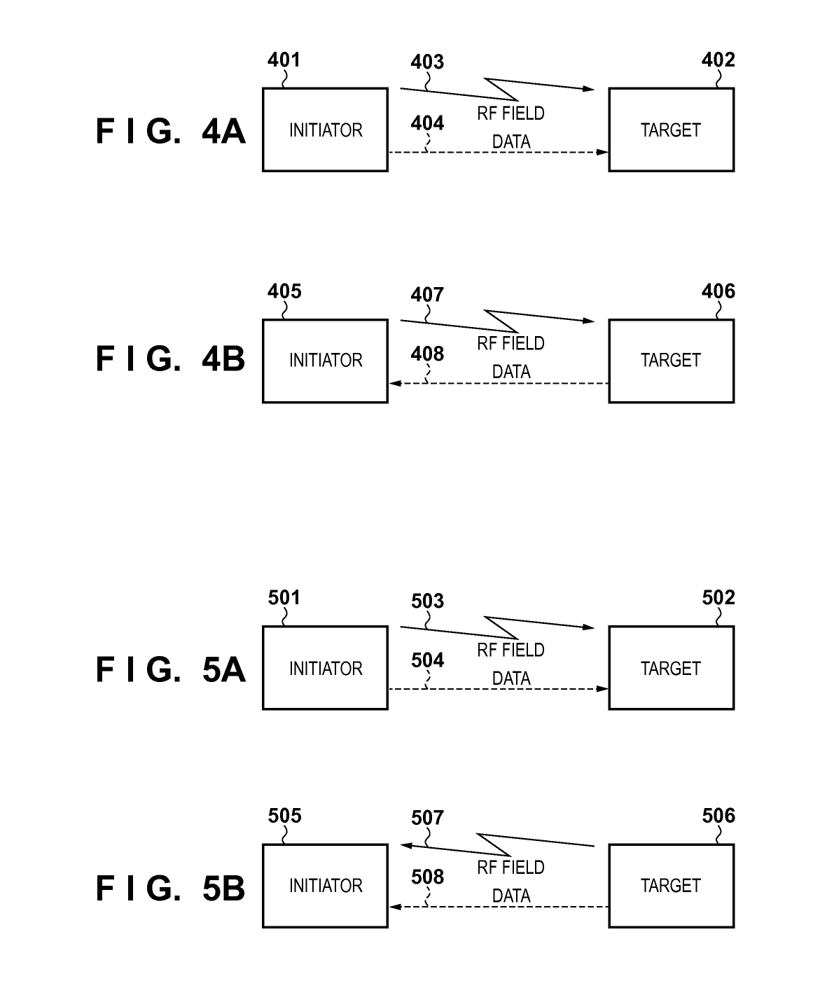

FIGS. 3A and 3B are views each schematically showing the outer appearance of the MFP 300. FIG. 3A is a perspective view showing the outer appearance and FIG. 3B is a plan view showing the MFP.

A document table 301 is a transparent glass table and is used to place an original to be read by the scanner. A document cover 302 is used to prevent reading light from externally leaking at the time of reading by the scanner. A printing paper insert port 303 is used to set paper sheets of various sizes. The paper sheets set in the printing paper insert port 303 are conveyed to a printing unit (printer engine) one by one, undergo desired printing, and are discharged from a printing paper discharge port 304.

As shown in FIG. 3B, an operation display unit 305 and an NFC unit 306 are arranged on the document cover 302. The operation display unit 305 includes keys for various operations and an LCD display, with which it is possible to perform an operation and make settings for the MFP 300. The NFC unit 306 is a unit used to perform short distance wireless communication, and the NFC unit is a place, close to which the user actually moves the mobile communication terminal 200. An effective communicable distance is about 10 cm from the NFC unit 306. A WLAN antenna 307 is used for WLAN communication, and is embedded in the document cover 302.

The NFC unit is used for low-speed communication, and the WLAN unit is used for high-speed communication.

NFC communication will be described next. For near field communication using an NFC unit, an apparatus which generates an RF (Radio Frequency) field (magnetic field) to start communication will be referred to as an initiator hereinafter. An apparatus which communicates with the initiator in response to an instruction sent by the initiator will be referred to as a target hereinafter. The communication modes of the NFC unit include a passive mode and active mode. In the passive mode, the target responds to an instruction sent by the initiator by performing load modulation. On the other hand, in the active mode, the target responds to an instruction sent by the initiator with an RF field generated by the target itself.

FIGS. 4A and 4B are block diagrams showing the concept of the passive mode in NFC communication.

FIG. 4A shows a case in which an initiator 401 transmits data 404 to a target 402 in the passive mode. The initiator 401 generates an RF field (magnetic field) 403. The initiator 401 modulates the RF field 403 to transmit the data 404 to the target 402. FIG. 4B shows a case in which a target 406 transfers data 408 to an initiator 405 in the passive mode. Similarly to FIG. 4A, the initiator 405 generates an RF field 407. The target 406 performs load modulation for the RF field 407 to transmit the data 408 to the initiator 405.

FIGS. 5A and 5B are block diagrams showing the concept of the active mode in NFC communication.

FIG. 5A shows a case in which an initiator 501 transmits data 504 to a target 502 in the active mode. The initiator 501 generates an RF field 503. The initiator 501 modulates the RF field 503 to transmit the data 504 to the target 502. Upon completion of the data transmission, the initiator 501 stops generating the RF field 503. FIG. 5B shows a case in which a target 506 transmits data 508 to an initiator 505 in the active mode. The target 506 generates an RF field 507. The target 506 transmits the data 508 with the RF field 507 generated by itself. Upon completion of the data transmission, the target 506 stops generating the RF field 507.

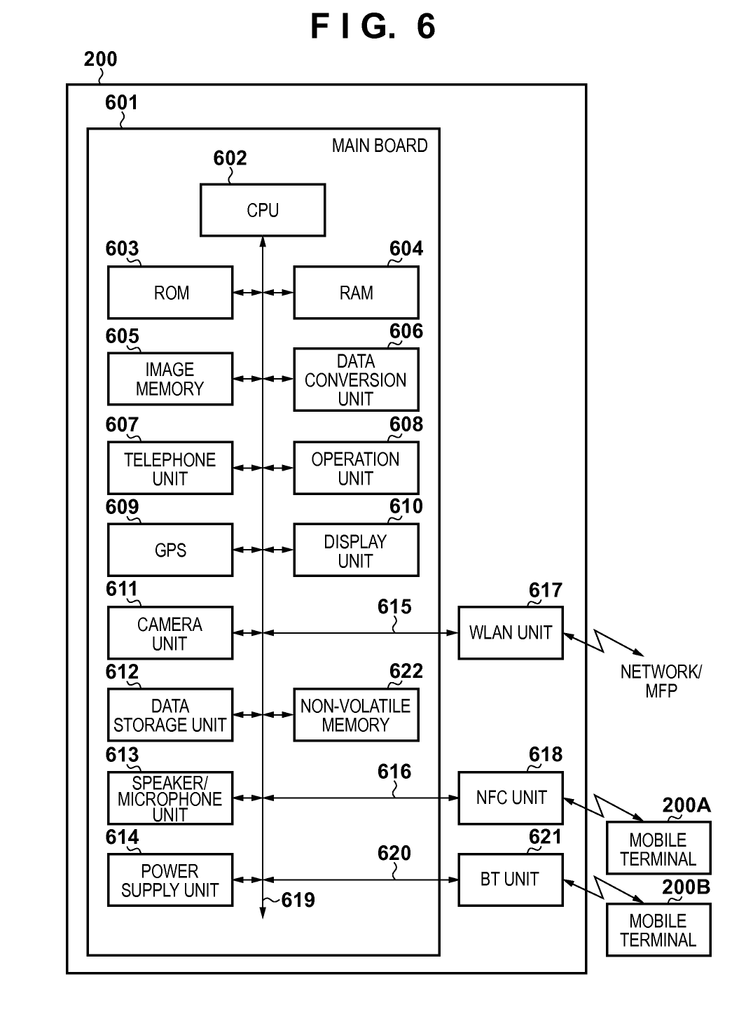

FIG. 6 is a block diagram showing the arrangement of the mobile communication terminal 200.

The mobile communication terminal 200 includes a main board 601 for controlling the apparatus as a whole, a WLAN unit 617 for performing WLAN communication, an NFC unit 618 for performing NFC communication, and a BT unit 621 for performing BT communication using Bluetooth®. Note that although FIG. 6 shows a mobile communication terminal as the communication party of the NFC unit 618 or BT unit 621, the communication party is not limited to this. For example, the NFC unit or BT unit can communicate with any apparatus implementing the same communication protocol, as a matter of course. Furthermore, a WLAN unit may be arranged instead of the BT unit 621 to perform high-speed wireless communication using a protocol conforming to, for example, IEEE802.1X or IEEE802.11n. The WLAN unit 617, NFC unit 618, and BT unit 621 will be collectively referred to as a communication unit hereinafter.

A CPU 602 of the main board 601 serves as a system control unit for controlling the mobile communication terminal 200 as a whole. A ROM 603 stores control programs, an embedded operating system (OS) program, and the like to be executed by the CPU 602. In this embodiment, each control program stored in the ROM 603 performs software control such as scheduling or task switching under the management of the embedded OS stored in the ROM 603. A RAM 604 is formed from an SRAM or the like. The RAM 604 stores program control variables, setting values registered by the user, management data for the mobile communication terminal 200, and the like, and also is used as various work buffer areas.

An image memory 605 is formed from a DRAM or the like, and temporarily stores image data received via the communication unit or image data read out from a data storage unit 612 for processing by the CPU 602. A non-volatile memory 622 is formed from a flash memory or the like, and stores data to be saved even after power-off. Examples of the data are telephone directory data and information of devices connected in the past. Note that the memory structure is not limited to that shown in FIG. 6. The image memory 605 and RAM 604 may share a memory, or data may be backed up in the data storage unit 612. Although the DRAM is used in this embodiment, the present invention is not limited to this, and a hard disk, a non-volatile memory, or the like may be used.

A data conversion unit 606 performs analysis of a page description language (PDL) and the like, and data conversion such as color conversion and image conversion. A telephone unit 607 controls a telephone line, and processes voice data input/output through a speaker/microphone unit 613, thereby implementing communication by telephone. An operation unit 608 controls a signal generated by the operation unit 204 described with reference to FIG. 2. A GPS (Global Positioning System) 609 acquires the current latitude and longitude. A display unit 610 electronically controls display contents of the display unit 203 described with reference to FIG. 2, and can display various input operations, the operation state and status of the MFP 300, and the like.

A camera unit 611 has a function of electronically recording and encoding an image input via a lens. An image captured by the camera unit 611 is saved in the data storage unit 612. The speaker/microphone unit 613 implements a function of inputting or outputting voice for the telephone function, an alarm notification function, and the like. A power supply unit 614 includes a portable battery, and controls the power supply. Power supply states include a battery empty state corresponding to a zero battery level, a power off state before the user presses the power key 205, an active state (power-on state) in which the apparatus is normally activated, and a power-saving state in which the apparatus is activated but in a power-saving mode.

The mobile communication terminal 200 integrates three (3) wireless communication units as communication units for performing data communication with another device such as an MFP, and can perform wireless communication by WLAN, NFC, and Bluetooth®. The communication unit converts data into a packet, and transmits the packet to another device such as mobile terminals 200A, 200B. The communication unit also converts a packet from another external device into data, and transmits the converted data to the main board 601. The WLAN unit 617, NFC unit 618, and BT unit 621 are connected by bus cables 615, 616, and 620, respectively. The WLAN unit 617, NFC unit 618, and BT unit 621 implement communication conforming to the respective specifications. The NFC unit will be described in detail later.

The above-described components 603 to 614, 617, 618, 621, and 622 are connected to each other via a system bus 619 managed by the CPU 602.

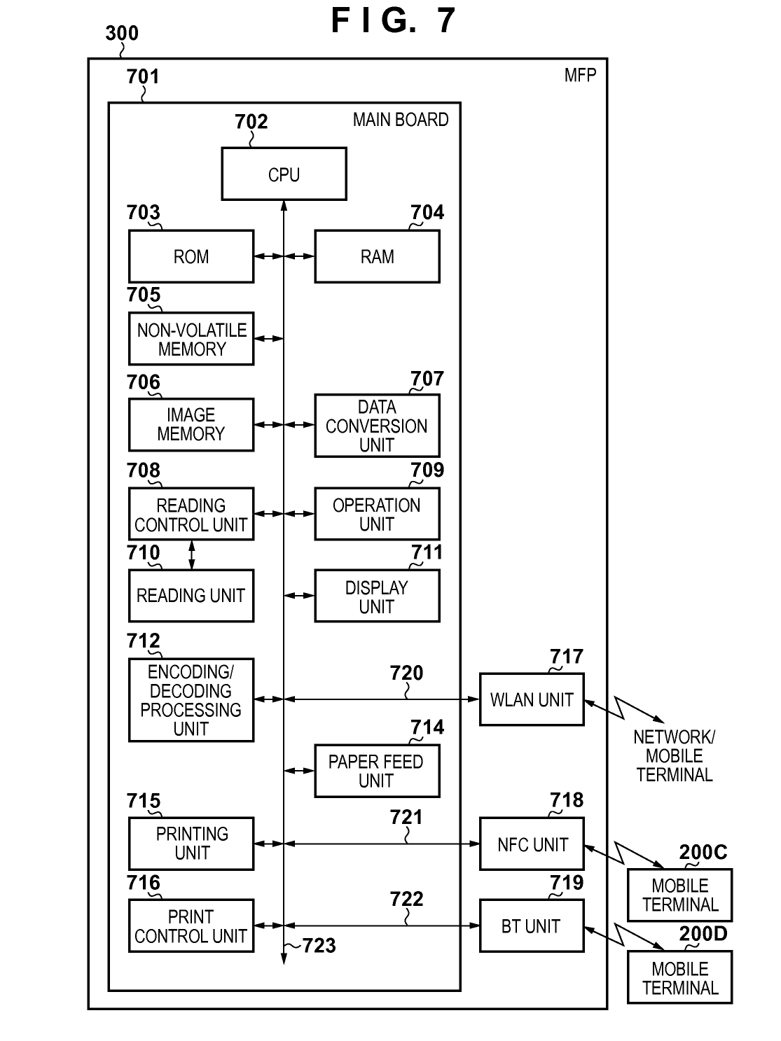

FIG. 7 is a block diagram showing the schematic arrangement of the MFP 300.

The MFP 300 includes a main board 701 for controlling the apparatus as a whole, a WLAN unit 717 for performing WLAN communication, an NFC unit 718 for performing NFC communication, and a BT unit 719 for performing BT communication. Note that although FIG. 7 shows mobile communication terminals 200C, 200D as the communication party of the NFC unit 718 or BT unit 719, the communication party is not limited to this. For example, the NFC unit or BT unit can communicate with any apparatus implementing the same communication protocol, as a matter of course. Furthermore, a WLAN unit may be arranged instead of the BT unit 719 to perform high-speed wireless communication using a protocol conforming to, for example, IEEE802.1X or IEEE802.11n. The WLAN unit 717, NFC unit 718, and BT unit 719 will be collectively referred to as a communication unit hereinafter.

A CPU 702 of the main board 701 serves as a system control unit for controlling the MFP 300 as a whole. A ROM 703 stores control programs, an embedded operating system (OS) program, and the like to be executed by the CPU 702. In this embodiment, each control program stored in the ROM 703 performs software control such as scheduling or task switching under the management of the embedded OS stored in the ROM 703.

A RAM 704 is formed from an SRAM or the like. The RAM 704 stores program control variables, setting values registered by the user, management data for the MFP 300, and the like, and also is used as various work buffer areas. A non-volatile memory 705 is formed from a flash memory or the like, and stores data to be saved even after power-off. More specifically, the non-volatile memory 705 stores network connection information, user data, and the like. An image memory 706 is formed from a DRAM or the like, and stores image data received via the communication unit, image data processed by an encoding/decoding processing unit 712, and image data acquired from a memory card via a memory card controller (not shown). Like the memory structure of the mobile communication terminal 200, the memory structure is not limited to this. A data conversion unit 707, for example, performs analysis of page description language (PDL) data and the like, and conversion of image data into print data.

An image signal generated when a reading unit 710 controlled by a reading control unit 708 causes a CIS image sensor to optically read an original undergoes various image processes such as binarization processing and half-toning processing via an image processing control unit (not shown), thereby outputting high-resolution image data.

An operation unit 709 and a display unit 711 represent the operation display unit 305 described with reference to FIGS. 4A and 4B. The encoding/decoding processing unit 712 executes encoding/decoding processing and resizing processing for the image data (JPEG, PNG, or the like) handled by the MFP 300.

A paper feed unit 714 holds printing media such as printing paper sheets. The paper feed unit 714 can perform a paper feed operation under the control of a print control unit 716. Especially, the paper feed unit may include a plurality of paper feed units to hold a plurality of kinds of printing paper sheets in one apparatus. In this case, the print control unit 716 controls to select a paper feed unit to feed printing paper sheets.

The print control unit 716 converts image data to be printed into high-resolution image data by executing, via the image processing control unit (not shown), various image processes such as smoothing processing, printing density correction processing, and color correction, and outputs the obtained image data to a printing unit 715. The print control unit 716 periodically reads out information in the printing unit 715 to update status information stored in the RAM 704. More specifically, the print control unit 716 updates the ink residual of an ink tank, the state of a printhead, and like.

Similarly to the mobile communication terminal 200, the MFP 300 integrates three (3) wireless communication units. Each function is the same as that of the mobile communication terminal 200, and a description thereof will be omitted. Note that the WLAN unit 717, NFC unit 718, and BT unit 719 are connected by bus cables 720, 721, and 722, respectively.

The above-described components 702 to 719 are connected to each other via a system bus 723 managed by the CPU 702.

The WLAN unit shown in FIGS. 6 and 7 can perform high-speed wireless communication conforming to, for example, IEEE802.1X or IEEE802.11n.

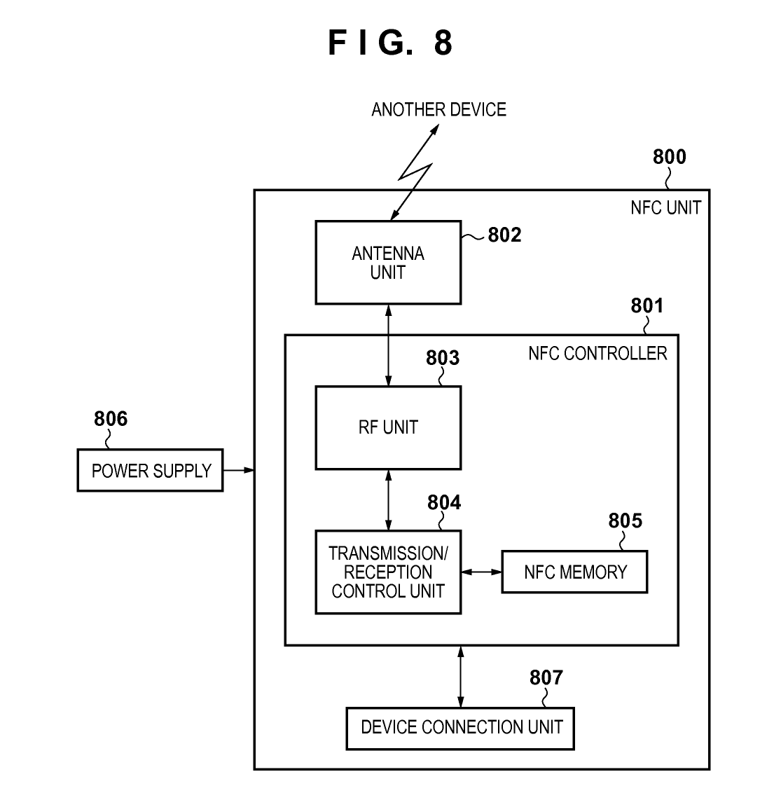

FIG. 8 is a block diagram showing the detailed arrangement of the NFC unit used as the NFC unit 618 or NFC unit 718.

An NFC unit 800 includes an NFC controller 801, an antenna unit 802, an RF unit 803, a transmission/reception control unit 804, an NFC memory 805, and a device connection unit 807. A power supply 806 is provided outside the NFC unit 800. The antenna unit 802 receives/transmits a radio wave or a carrier from/to another NFC device. The RF unit 803 has a function of modulating/demodulating an analog signal into/from digital signal. The RF unit 803 includes a synthesizer to identify the frequency of a band or a channel and control the band or channel using frequency assignment data. The transmission/reception control unit 804 performs control concerning transmission/reception, including assembling and disassembling of a transmission/reception frame, preamble addition and detection, and frame identification. The transmission/reception control unit 804 also controls the NFC memory 805 to input/output various data and programs.

The NFC memory 805 is formed from a non-volatile memory. When the NFC unit operates in the active mode, it receives power via the power supply 806, and communicates with another device via the device connection unit 807 or communicates with another NFC device existing within coverage by a carrier transmitted/received via the NFC controller 801. To the contrary, when the NFC unit operates in the passive mode, it receives a radio wave from another NFC device via the antenna unit 802, and receives power from the other NFC device by electromagnetic induction. The NFC unit then communicates with the other NFC device by modulating the carrier, thereby transmitting/receiving data including information stored in the NFC memory 805.

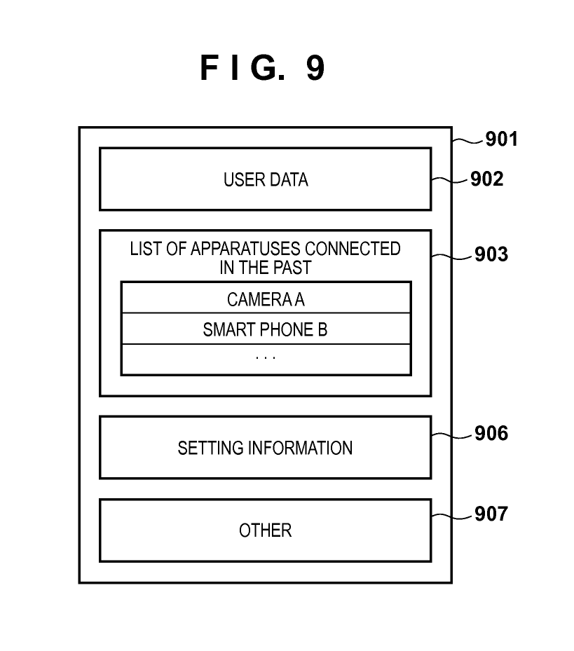

FIG. 9 is a block diagram showing the internal structure of the non-volatile memory (flash memory) 705 of the MFP 300.

Referring to FIG. 9, reference numeral 901 denotes an entire flash memory. User data 902 stores information about the user, including a FAX number, a communication history, and network information. A list 903 of apparatuses connected in the past stores a list of apparatuses to which the MFP 300 has been connected so far. If, for example, the MFP 300 communicated with a smart phone using NFC, the identifier of the smart phone is stored. If P2P communication with a smart phone was performed via WLAN, identification information for WLAN connection is stored. More specifically, if WPS (Wi-Fi Protected Setup) is used for WLAN connection, WPS Credential authentication information is stored.

If the MFP 300 was connected to a smart phone by Bluetooth®, OOB authentication information is stored. If the MFP 300 was connected to the server apparatus 101 via the network 100, the network information of the server apparatus 101 is stored. Setting information 906 stores the setting information of the MFP 300. For example, menu items such as a print mode, correction information of an inkjet printhead, and the like are stored. Other 907 stores another non-volatile information.

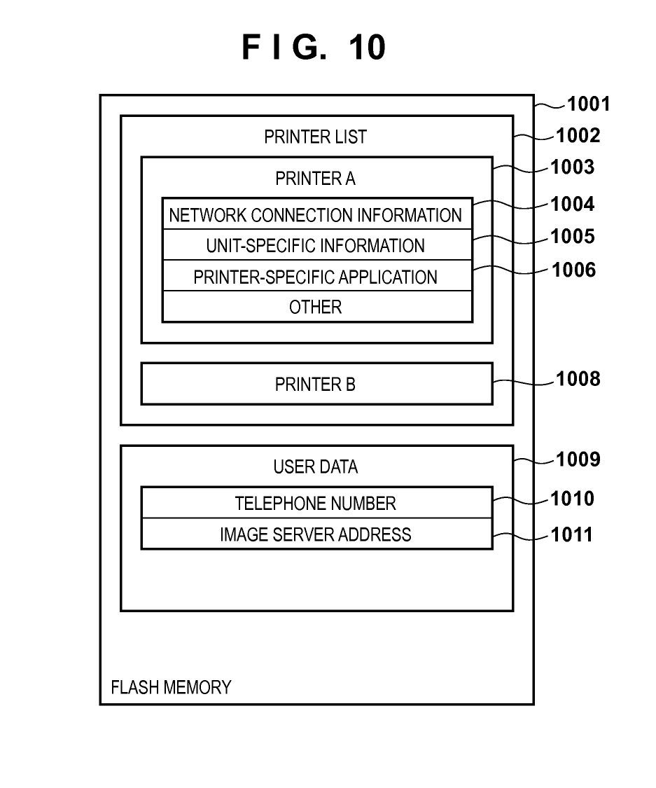

FIG. 10 is a block diagram showing the internal structure of the non-volatile memory (flash memory) 622 of the mobile communication terminal 200.

Referring to FIG. 10, reference numeral 1001 denotes an entire non-volatile memory. A printer list 1002 stores a list of printers to which the mobile communication terminal 200 has been connected so far. A printer A 1003 is an example of the printer. Network connection information 1004 stores network connection information when the printer A was connected to a network. If, for example, the printer A was connected via LAN, the address of the connection destination and authentication information are stored. A unit-specific information 1005 stores information about the printer, for example, information of the printing resolution and the number of inks used of the printer.

A printer-specific application 1006 stores an application for performing processing (conversion of image data into a format conforming to the specifications of the printer, band processing control, communication control, and the like) specific to the printer. This information is downloaded via the network 100 or saved when the terminal is connected to the printer for the first time. A printer B 1008 is an example of another printer. User data 1009 stores data about the user, for example, a telephone number 1010 and an image server address 1011.

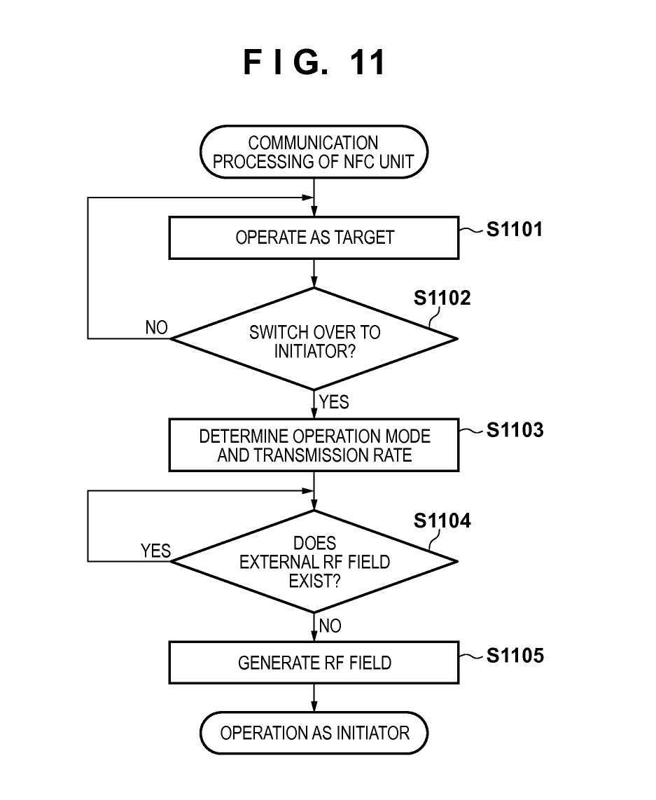

FIG. 11 is a flowchart when the NFC unit operates as an initiator.

In step S1101, every NFC unit operates as a target, and stands by for an instruction from an initiator. In step S1102, the NFC unit can switch over to an initiator in response to a request from an application for controlling communication conforming to the NFC specifications. If the NFC unit responds to the request to switch over to an initiator, the process advances to step S1103 in which the application selects one of the active mode and the passive mode, and determines the transmission rate.

In step S1104, the initiator detects the existence of an RF field output from an apparatus other than itself. If an external RF field exists, the initiator does not generate the RF field of its own; otherwise, the process advances to step S1105 in which the initiator generates the RF field of its own.

By executing the above steps, the NFC unit starts the operation as the initiator.

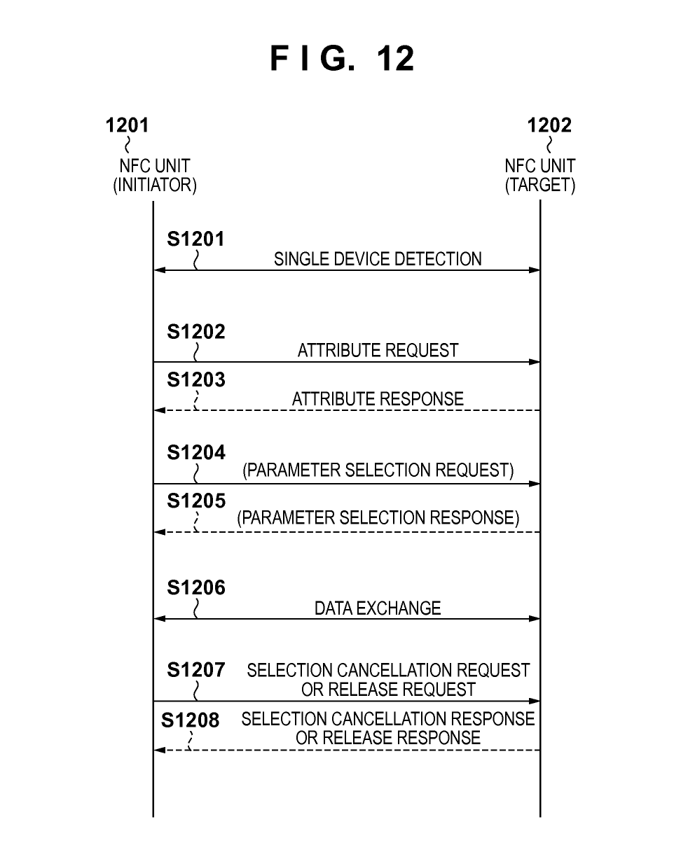

FIG. 12 is a sequence chart showing the sequence of performing data exchange in the passive mode. A case will be described in which an NFC unit (first NFC unit) 1201 operates as an initiator and an NFC unit (second NFC unit) 1202 operates as a target.

In step S1201, the NFC unit 1201 performs single device detection to specify the NFC unit 1202. In step S1202, the NFC unit 1201 transmits, as an attribute request, the identifier of its own, the bit transmission rate of transmission/reception, the effective data length, and the like. This attribute request has general purpose bytes which can be arbitrarily selected and used. Upon receiving an effective attribute request, the NFC unit 1202 transmits an attribute response in step S1203. Note that transmission from the NFC unit 1202 is performed by load modulation, and data transmission by load modulation is represented by a dotted arrow in FIG. 12.

Upon confirming an effective attribute response, the NFC unit 1201 can transmit a parameter selection request, and change the parameters of a subsequent transmission protocol in step S1204. Parameters included in the parameter selection request are the transmission rate and effective data length. Upon receiving an effective parameter selection request, the NFC unit 1202 transmits a parameter selection response, and changes the parameters in step S1205. Note that steps S1204 and S1205 may be omitted if the parameters are not changed.

In step S1206, the NFC unit 1201 and the NFC unit 1202 exchange data by sending a data exchange request and a data exchange response. With the data exchange request and response, it is possible to transmit, as data, information for an application of the communication party. If the data size is large, the data can be divided and transmitted.

Upon completion of the data exchange, the NFC unit 1201 transmits one of a selection cancellation request and a release request in step S1207. If the NFC unit 1201 transmits the selection cancellation request, the NFC unit 1202 transmits a selection cancellation response in step S1208. Upon receiving the selection cancellation response, the NFC unit 1201 releases the attributes indicating the NFC unit 1202, and the process returns to step S1201. On the other hand, if the NFC unit 1201 transmits the release request, the NFC unit 1202 transmits a release response to return to the initial state in step S1208. Upon receiving the release response, the NFC unit 1201 can return to the initial state since the target has been completely released.

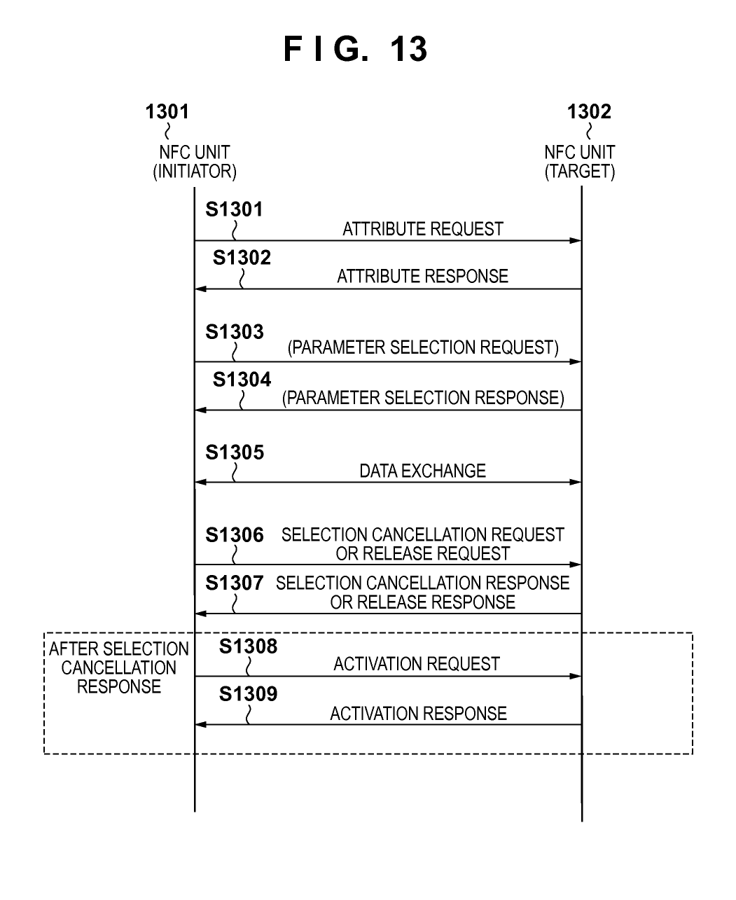

FIG. 13 is a sequence chart showing the sequence of performing data exchange in the active mode. A case will be described in which an NFC unit (first NFC unit) 1301 operates as an initiator and an NFC unit (second NFC unit) 1302 operates as a target.

In step S1301, the NFC unit 1301 transmits, as an attribute request, the identifier of its own, the bit transmission rate of transmission/reception, the effective data length, and the like. Upon receiving an effective attribute request, the NFC unit 1302 transmits an attribute response in step S1302. Note that transmission from the NFC unit 1302 is performed by an RF field generated by itself. Upon completion of data transmission, therefore, both the NFC units stop generating RF fields.

Upon confirming an effective attribute response, the NFC unit 1301 can transmit a parameter selection request, and change the parameters of a transmission protocol in step S1303. Parameters included in the parameter selection request are the transmission rate and effective data length. Upon receiving an effective parameter selection request, the NFC unit 1302 transmits a parameter selection response, and changes the parameters in step S1304. Note that similarly to the passive mode, steps S1303 and S1304 may be omitted if the parameters are not to be changed.

In step S1305, the NFC unit 1301 and the NFC unit 1302 exchange data by sending a data exchange request and a data exchange response. With the data exchange request and response, it is possible to transmit, as data, information for an application. If the data size is large, the data can be divided and transmitted.

Upon completion of the data exchange, the NFC unit 1301 transmits one of a selection cancellation request and a release request in step S1306. If the NFC unit 1301 transmits the selection cancellation request, the NFC unit 1302 transmits a selection cancellation response in step S1307. Upon receiving the selection cancellation response, the NFC unit 1301 releases the attributes indicating the NFC unit 1302. After that, the NFC unit 1301 transmits an activation request to another target with a known identifier in step S1308. Upon receiving the activation request, the target transmits an activation response in step S1309, and the process returns to step S1301. On the other hand, if the NFC unit 1301 transmits the release request, the NFC unit 1302 transmits a release response, and returns to the initial state in step S1309. Upon receiving the release response, the NFC unit 1301 can return to the initial state since the target has been completely released.

The communication rate of NFC is relatively as low as several hundred bps. Therefore, authentication and the like are performed using NFC, and a large amount of data is transmitted using higher-speed WLAN, thereby achieving efficient data transfer.

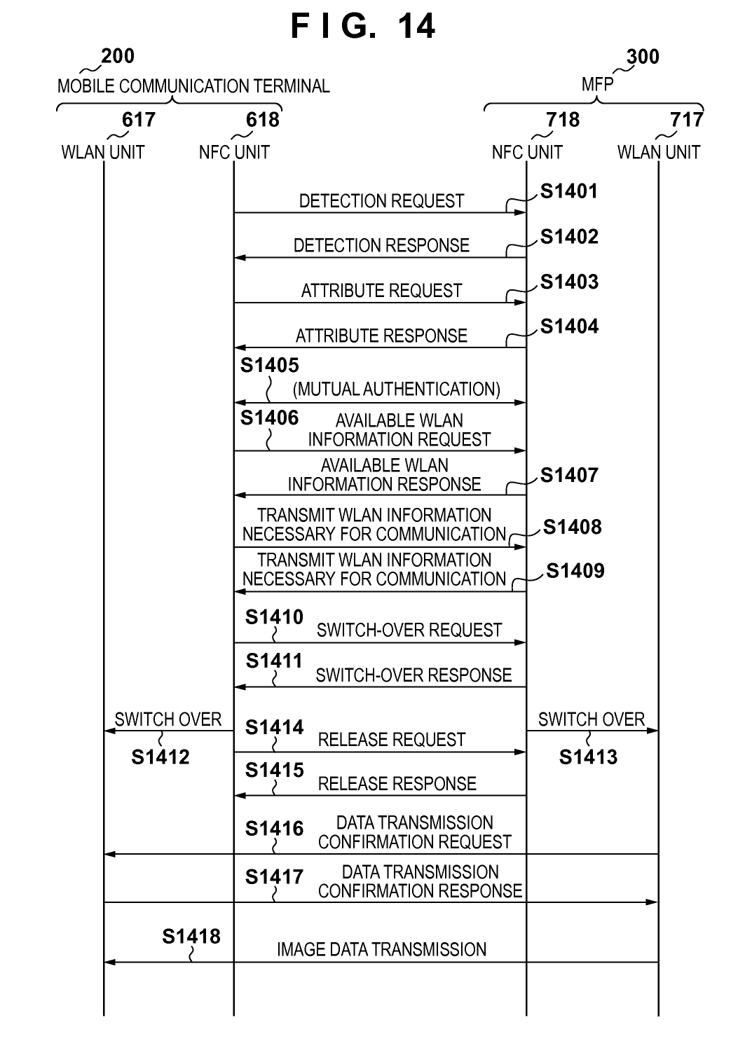

FIG. 14 is a sequence chart showing the sequence of performing data transfer while switching between NFC and WLAN. FIG. 14 shows an example of so-called push-type communication in which the MFP 300 takes initiative for transferring, to the mobile communication terminal 200, image data generated by reading an image original using the scanner function of the MFP 300.

In step S1401, to establish NFC communication with the MFP 300, the NFC unit 618 serves as an initiator to detect the NFC unit 718 as a target. If the NFC unit 718 has been correctly detected, the NFC unit 718 transmits a detection response in step S1402. Note that in the example shown in FIG. 14, the mobile communication terminal 200 serves as an initiator. In fact, however, the MFP 300 may become an initiator based on an input through the operation display unit 305 or the like. Upon correctly receiving the detection response, in step S1403 the NFC unit 618 transmits an attribute request for performing NFC communication. Upon receiving the attribute request, the NFC unit 718 returns an attribute response in step S1404. With the attribute request and response, the NFC_IDs of the initiator and target are transmitted, and the communication parties are specified by the NFC_IDs.

In step S1405, mutual authentication is performed, thereby enabling to pass an encryption key for data encryption. Note that if, for example, it is not necessary to pass an encryption key, this mutual authentication need not be performed. In step S1406, the NFC unit 618 requests information about a communication protocol available in the MFP 300, to the NFC unit 718. This request contains information about a communication protocol available in the mobile communication terminal. Upon receiving the request, the NFC unit 718 can recognize that the mobile communication terminal can use WLAN communication. In step S1407, the NFC unit 718 responds to the request received in step S1406 with the information about the communication protocol available in itself. Both the apparatuses, therefore, can identify the communication protocol available with each other.

Assume that the mobile communication terminal serving as the initiator has determined that it is possible to perform data transfer at speed using the recognized WLAN communication protocol higher than that with NFC, and thus communication is performed by switching over to WLAN. Note that the MFP may determine switch-over to WLAN.

In this case, in steps S1408 and S1409, for example, the apparatuses exchange information necessary for WLAN communication, such as addresses for specifying the communication parties. The process then advances to step S1410, in which the NFC unit 618 transmits a request to switch over from the NFC communication to the WLAN communication. Upon receiving the switch-over request, the NFC unit 718 responds to it in step S1411.

Upon receiving a correct switch-over response, the NFC unit 618 is switched over to the WLAN unit 617 in step S1412, and the NFC unit 718 is switched over to the WLAN unit 717 in step S1413. After the switch-over operations, the NFC unit 618 transmits a release request in step S1414. Upon receiving the release request, the NFC unit 718 transmits a release response in step S1415, thereby terminating NFC communication.

Processing in step S1416 and subsequent steps executes WLAN communication based on the information for WLAN communication exchanged in steps S1408 and S1409.

In step S1416, the WLAN unit 717 confirms with the WLAN unit 617 whether or not data transfer is possible. The contents to be confirmed here include, for example, the capacity of free space to save image data to be transferred to the mobile communication terminal 200. Upon receiving the confirmation request, the WLAN unit 617 transmits an acknowledgement in step S1417. If a correct acknowledgement has been received, and it has been determined that data transfer is possible, the WLAN unit 717 transmits, to the WLAN unit 617, image data generated by the scanner function of the MFP 300 in step S1418. This processing enables to transfer a large amount of data using a higher-speed communication protocol.

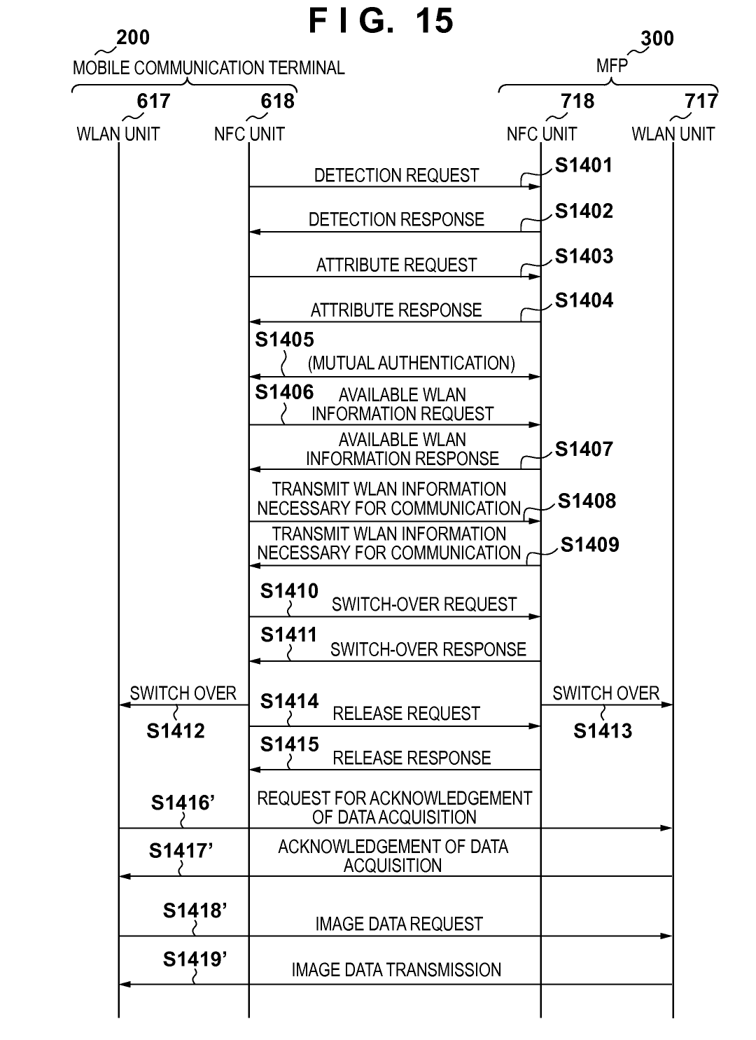

FIG. 15 is a sequence chart showing the sequence of performing so-called pull-type communication in which the mobile communication terminal 200 takes initiative for transferring, to itself, image data generated by reading an image original using the scanner function of the MFP 300. Note that the same step in FIG. 15 as that in FIG. 14 has the same reference symbol, and a description thereof will be omitted.

Referring to FIG. 15, after switching over from NFC communication to WLAN communication, the WLAN unit 617 transmits a request for acknowledgement of data acquisition to the WLAN unit 717 in step S1416′. The contents to be confirmed here include a data size of data to be transferred by the MFP 300. Upon receiving the request for acknowledgement of transfer data, the WLAN unit 717 transmits a response in step S1417′. If a correct response has been received, and it has been determined in consideration of the free space of the mobile communication terminal 200 that data transfer is possible, the WLAN unit 617 requests image data in step S1418′. Upon receiving a correct request, the WLAN unit 717 transmits the requested image data in step S1419′.

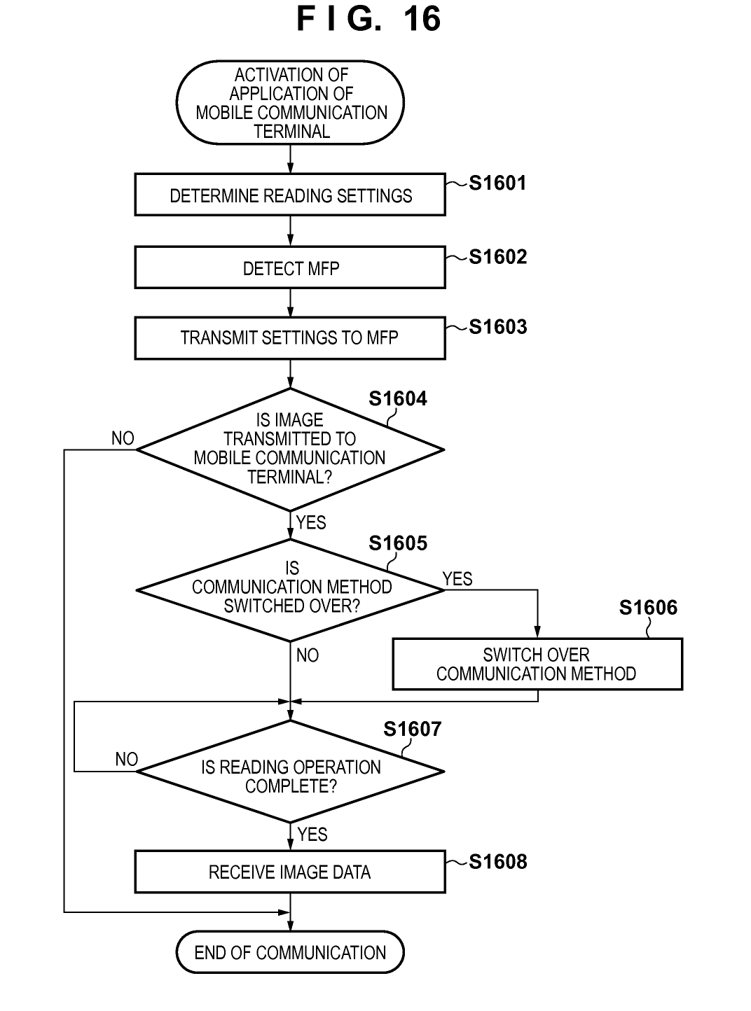

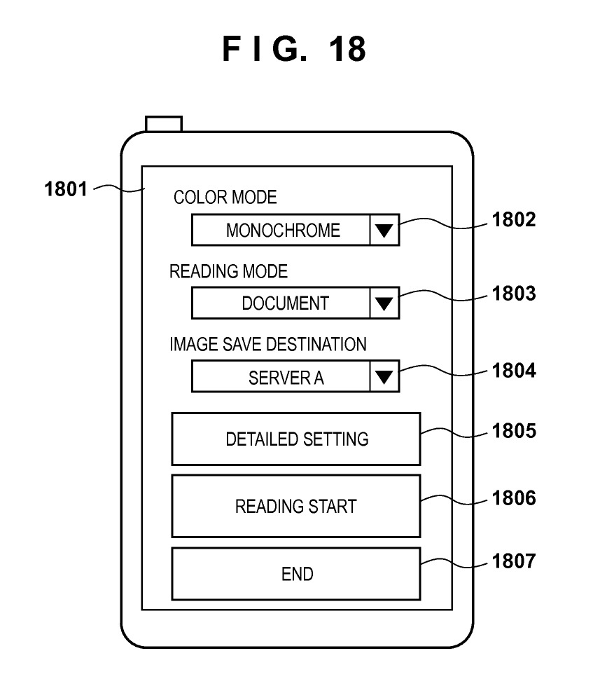

FIG. 16 is a flowchart illustrating processing executed by the mobile communication terminal from a time when an application of the mobile communication terminal is activated until communication with the MFP ends. Assume that the application has, for example, a user interface used by the user to input settings as shown in FIG. 18, and a function of causing the NFC unit of the mobile communication terminal to operate as an initiator.

In step S1601, the user uses the application of the mobile communication terminal to make settings for the scanner function of the MFP 300 and send an instruction to the scanner function. The settings and instruction are transmitted to the MFP. The settings include settings for a reading function such as the reading resolution of a scanner, and address settings used for transferring image data obtained by an image reading operation. Upon completion of the setting operation, a detection request/response, attribute request/response, and the like are transmitted/received using NFC communication to detect the MFP 300 in step S1602. Note that either the mobile communication terminal or MFP may serve as an initiator in this case. Upon detecting the MFP, the reading settings determined in step S1601 are transmitted to the MFP in step S1603.

In step S1604, the transfer destination of the image data determined in the reading settings is checked. If the image data is to be transferred to the mobile communication terminal, the process advances to step S1605. On the other hand, if the image data is to be transferred to an apparatus other than the mobile communication terminal, for example, the server apparatus 101, the process releases the target to terminate the communication. Note that the transfer destination of the image data has been decided in advance in the mobile communication terminal or MFP, it is not necessary to execute the processing in step S1604.

In step S1605, it is checked whether or not the image data is transferred using a communication method other than the NFC, such as WLAN. If the communication method is switched over from NFC communication to another communication method, the process advances to step S1606. If NFC communication continues, the process advances to step S1607. Note that the communication method of transferring the image data may be selected by the user in step S1601, may be automatically selected by the mobile communication terminal or MFP, or may have been decided in advance.

In step S1606, the communication method is switched over according to the sequence shown in FIG. 14 or 15. Note that since the sequence from a time when communication starts until mutual authentication is performed ends in step S1602, the processing of requesting information about an available WLAN protocol in step S1406 and subsequent steps is executed. If the mobile communication terminal or MFP cannot use the set communication method, the user is notified of it or alternative processing of selecting another available communication method is executed. If the communication method has been successfully switched over to that other than NFC communication, the NFC communication may be terminated.

Upon completion of the above processing, in step S1607 the process stands by for completion of processing of reading an image original by the scanner function of the MFP. Upon completion of the reading processing, the process advances to step S1608 by receiving a processing end notification or the like. In step S1608, the image data of the read image original is received. At this time, communication for receiving the image data is performed by the NFC communication or the communication method to which the NFC communication has been switched over in step S1606. Upon completion of reception of the image data, the communication is terminated. Note that if the communication is interrupted while receiving the data, error processing is executed. For example, the user is notified of the error by displaying it on the screen of the mobile communication terminal.

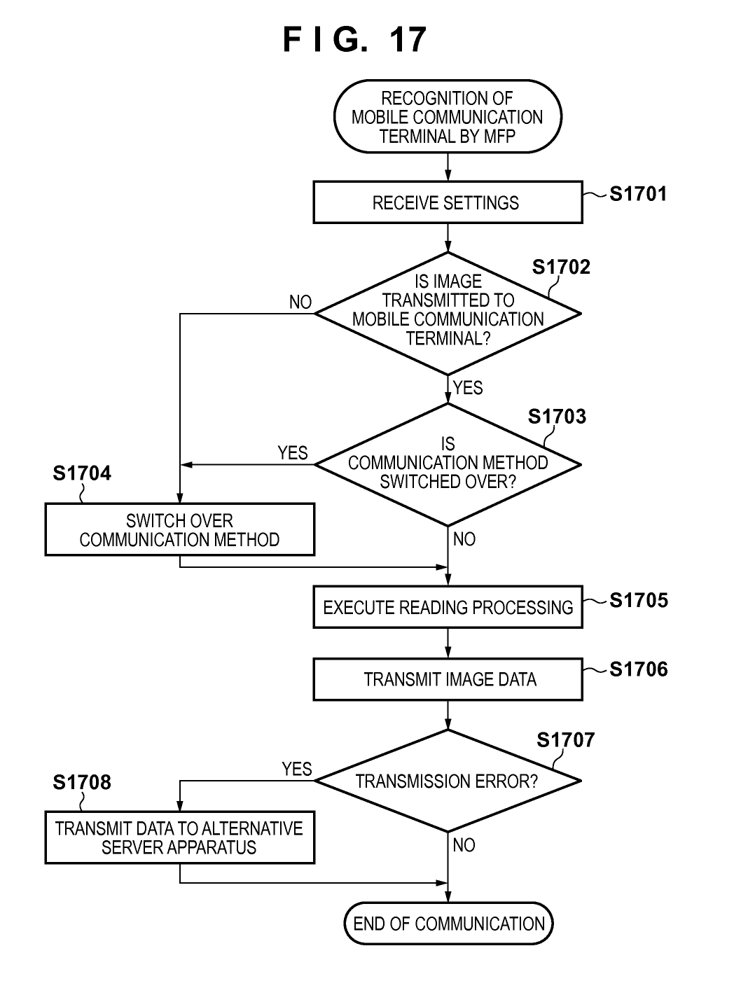

FIG. 17 is a flowchart illustrating processing executed by the MFP from a time when the mobile communication terminal is detected until communication ends. FIG. 17 shows processing in which the mobile communication terminal activates the scanner function of the MFP using NFC communication to transfer the image data of a read image original to the mobile communication terminal or server apparatus according to the NFC communication protocol or another communication protocol.

In step S1701, the MFP receives the settings for the scanner function, which have been decided by the user in step S1601 of FIG. 16. These settings include settings for the reading function such as the reading resolution of the scanner, and settings for addresses to which the image data obtained by an image reading operation is transferred. In step S1702, the received settings are decoded to check the transfer destination of the image data. If the image data is directly transferred to the mobile communication terminal, the process advances to step S1703; otherwise, the process advances to step S1704. Note that if the mobile communication terminal or MFP has decided in advance the transfer destination of the image data, it is not necessary to execute the processing in step S1702.

In step S1703, it is determined whether or not the communication method for transferring the image data is switched over from the NFC communication to another method. If the communication method is switched over, the process advances to step S1704; otherwise, the process advances to step S1705. In step S1704, the communication method is switched over according to the sequence shown in FIG. 14 or 15. Especially, if it is determined in step S1702 that the image data is not transferred to the mobile communication terminal, communication with the mobile communication terminal is disconnected, thereby starting communication with the specified transfer destination of the image data. If the MFP or the transfer destination of the image data cannot use the set communication method, the user of the mobile communication terminal is notified of it or alternative processing of selecting another available communication method is executed. If the communication method has been successfully switched over to that other than the NFC communication, the NFC communication may be terminated.

In step S1705, the scanner function of the MFP is used to read an image original. Upon completion of the reading processing, the mobile communication terminal is notified of it, and the process advances to step S1706. Note that although the image reading processing is executed after switching over the communication method in this example, the communication method may be switched over after or in parallel with the image reading processing.

In step S1706, the MFP transmits the image data to the specified transfer destination according to the specified communication protocol. The transfer destination and communication protocol have been decided in advance or in reading settings. Furthermore, in step S1707, the MFP monitors whether or not a transmission error has occurred, for example, whether or not the transfer destination moves out of coverage in wireless communication. If an error has occurred in communication with the transfer destination, the communication may be interrupted while transferring the image data. The process, therefore, advances to step S1708, in which the MFP performs transfer control to transmit the image data to an alternative server apparatus. By including, as an alternative destination, the address of another transfer destination such as a server apparatus in the settings received in step S1701, it is possible to transfer the remaining image data to the other transfer destination when communication with the transfer destination selected first fails. Note that the address of another transfer destination to which the image data is transmitted may be included in the settings, or may have been determined in advance by the MFP.

If no transmission error has occurred, the MFP terminates the communication upon completion of transfer of the image data. Even if a transmission error has occurred, the MFP terminates the communication upon completion of transfer of the image data to the alternative server apparatus. If the image data has been transferred to a transfer destination (for example, the server apparatus) other than the mobile communication terminal, the MFP may request the server apparatus serving as the alternative transfer destination to notify, with email or the like, the mobile communication terminal that transfer of the image data is complete.

FIG. 18 is a view showing an example of a screen for making settings, in step S1601 of FIG. 16, upon executing an application of the mobile communication terminal, for a scanner apparatus (or an MFP having a scanner function) for performing an image reading operation. The application has, for example, a user interface used by the user to input data, and a function of causing the NFC unit to operate as an initiator.

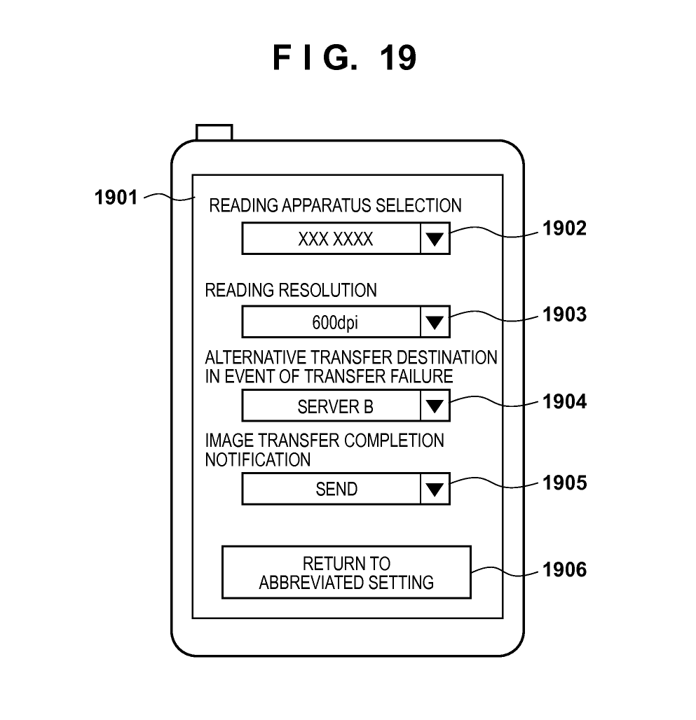

FIG. 19 is a view showing an example of a screen for making detailed settings for a scanner apparatus (or an MFP having a scanner function), to which the screen moves on when a detailed setting key 1805 shown in FIG. 18 is selected in step S1601 of FIG. 16.

As shown in FIG. 18, a color mode selection key 1802, a reading mode selection key 1803, an image save destination selection key 1804, the detailed setting key 1805, a reading start key 1806, and an end key 1807 are displayed on a setting screen 1801. The color mode selection key 1802 can be used to, for example, select an item associated with a reading color such as color or monochrome. The reading mode selection key 1803 can be used to, for example, select the type of image original to be read such as a document or photograph. The image save destination selection key 1804 is used to set the transfer destination of image data obtained by reading an image original. In this example, the mobile communication terminal, a server apparatus to which the mobile communication terminal can be connected, and the like are displayed as options. It is also possible to add or delete options of the transfer destination of the image data.

When the detailed setting key 1805 is selected, the screen moves on from the setting screen 1801 to a detailed setting screen 1901 shown in FIG. 19. When the reading start key 1806 is selected, the mobile communication terminal becomes an initiator in NFC communication, and starts to detect the scanner apparatus (in this embodiment, the MFP) as the communication party. When the end key 1807 is selected, the application ends. Before terminating the application, a message for reconfirming it and selection keys may be displayed. Note that the keys and display contents on the setting screen 1801 are merely illustrative, and the items, display contents, and positions may be arbitrarily changed. Furthermore, items common to general scanner apparatuses may be set on this screen, and the screen may be changed according to the scanner apparatus set on the screen shown in FIG. 19 (to be described later).

Detailed settings for the scanner apparatus (in this embodiment, the MFP) will be described with reference to FIG. 19.

A reading apparatus selection key 1902, a reading resolution selection key 1903, a key 1904 for selecting an alternative transfer destination in the event of a transfer failure, an image transfer completion notification selection key 1905, and a key 1906 for returning to abbreviated setting are displayed on the detailed setting screen 1901. The reading apparatus selection key 1902 is used to select a scanner apparatus (in this embodiment, an MFP) as the communication party to which the contents set on the screen are transmitted. Apparatuses with which have been communicated in the past are displayed as options here, and the user can add a new option from the displayed apparatuses. To add a new option, for example, a scanner apparatus or MFP may be recognized by performing NFC communication or the like in addition to transmission of the settings, or the user may search for scanner apparatuses on the Web site and select one of them. If the selected scanner apparatus is different from that with which has been actually communicated, the user may be notified of the error and instructed to change the item, or processing of reading an image original may be executed according to settings similar to the input settings. The reading resolution selection key 1903 can be used to select the reading resolution of the scanner apparatus. Since this setting may be different for each apparatus, only selectable settings for the selected apparatus may be presented as options to the user.

The key 1904 for selecting an alternative transfer destination in the event of a transfer failure can be used to select a transfer destination different from that selected in FIG. 18 for transmitting the remaining image data even in a case where communication is interrupted before starting to transfer the image data or while transferring the image data. For example, the mobile communication terminal, a server apparatus to which the mobile communication terminal can be connected, and the like are displayed as options. It is also possible to add or delete options of the transfer destination of the image data, or no alternative transfer destination may be set.

The image transfer completion notification selection key 1905 can be used to select, when the image data is transferred to an apparatus other than the mobile communication terminal, whether or not to send a notification that transfer of the image data is complete. Assume that it is selected that such notification is sent. In this case, if the mobile communication terminal has recognized that transfer is complete, for example, if the mobile communication terminal has correctly received the image data, a notification need not be sent. When the key 1906 for returning to abbreviated setting is selected, the displayed screen returns from the detailed setting screen 1901 to the setting screen 1801 shown in FIG. 18. Note that the keys and display contents on the detailed setting screen 1901 are merely illustrative, and the items, display contents, and positions may be arbitrarily changed.

According to the above-described embodiment, it is possible to use high-speed WLAN to transfer, to the mobile communication terminal, image data obtained by executing the scanner function of the MFP. Furthermore, even if communication is interrupted while transferring the image data, for example, the MFP can transfer the image data to an alternative apparatus such as a server apparatus, and then the mobile communication terminal can acquire the image data from the server apparatus via a network.

This arrangement can prevent a large amount of image data from being stored in the MFP with a relatively small-capacity memory for a long time, thereby enabling to efficiently use the MFP. On the other hand, even if the mobile communication terminal operating with a battery power supply cannot receive image data because the battery has run out, it can acquire the desired image data from the server apparatus after the battery is exchanged or the battery is recharged.

Note that a case in which the MFP transmits scanned data has been described in the above embodiment, the present invention is not limited to this, and the MFP may transmit various data. For example, the present invention is applicable to a case where image data stored in either an internal memory of the MFP or an external memory attached to the MFP is transmitted. In this case, the MFP 300 receives information, such as a file name, which identifies data to be transmitted from the mobile communication terminal 200 by NFC communication, and transmits the identified data based on the information by WLAN.

Furthermore, a case in which the MFP transmits data to the server by WLAN has been described in the above embodiment. The present invention, however, is not limited to this, and various wireless communication methods such as Bluetooth® can be used. Also, the MFP may transmit data to the server by wired communication.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-048616, filed Mar. 5, 2012, which is hereby incorporated by reference herein in its entirety.

What is claimed is:

1. A wireless communication apparatus comprising:
a wireless communication unit configured to be able to communicate with a communication device according to each of a first wireless communication method and a second wireless communication method that has a communicable range wider than that in the first communication method;
a reception unit configured to receive a request for executing predetermined processing and information for performing wireless communication according to the second wireless communication method with an output destination of data obtained by executing the predetermined processing, by performing wireless communication according to the first wireless communication with the communication device in the wireless communication unit;
an execution unit configured to execute the predetermined processing upon receiving the request; and
an output unit configured to output the data obtained by executing the predetermined processing by the execution unit, to the output destination, by performing wireless communication according to the second wireless communication method with the output destination in the wireless communication unit, based on the information received by the reception unit.

2. The apparatus according to claim 1, wherein the information designates the communication device as the output destination, and
the output unit outputs the data to the communication device, based on the information.

3. The apparatus according to claim 1, wherein the information designates the communication device and a server apparatus as the output destination, and
the output unit outputs the data to the communication device or the server apparatus, based on the information.

4. The apparatus according to claim 3, wherein the output unit performs first output control for outputting the data to the communication device according to the second wireless communication method, based on the information, and
in a case where an error occurs during the first output control, the output unit further performs second output control for outputting the data to the server apparatus according to the second wireless communication method, based on the information.

5. The apparatus according to claim 1, wherein the output unit outputs the data to the output destination, by using push-type communication according to the second wireless communication method in the wireless communication unit.

6. The apparatus according to claim 1, wherein the wireless communication unit is operative according to a NFC communication protocol in wireless communication according to the first wireless communication method.

7. The apparatus according to claim 6, wherein the wireless communication unit serves as a target in the NFC communication protocol, and
the reception unit receives the request and the information from the communication device serving as an initiator in the NFC communication protocol via the wireless communication unit.

8. The apparatus according to claim 1, wherein in a case where the wireless communication unit receives a request for switching over a wireless communication method from the first communication method to the second communication method from the communication device using the first wireless communication method, the wireless communication unit switches over the wireless communication method from the first communication method to the second communication method so that the output unit outputs the data using the second communication method.

9. The apparatus according to claim 1, wherein the execution unit causes a reading apparatus to read an original as the predetermined processing, and
the output unit outputs image obtained by reading the original in the reading apparatus, as the data.

10. A communication method applied to a wireless communication apparatus including a wireless communication unit, comprising:
wirelessly communicating with a communication device according to each of a first wireless communication method and a second wireless communication method that has a communicable range wider than that in the first wireless communication method;
receiving a request for executing predetermined processing, and information for performing wireless communication according to the second wireless communication method with an output destination of data obtained by executing the predetermined processing, by performing wireless communication according to the first wireless communication with the communication device;
executing the predetermined processing upon receiving the request; and
outputting the data obtained by executing the predetermined processing, to the output destination, by performing wireless communication according to the second wireless communication method with the output destination, based on the received information.

11. The communication method according to claim 10, wherein the information designates the communication device as the output destination, and
the data is outputted to the communication device, based on the information.

12. The communication method according to claim 10, wherein the information designates the communication device and a server apparatus as the output destination, and
the data is outputted to the communication device or the server apparatus, based on the information.

13. The communication method according to claim 12, wherein the outputting step includes performing:
first output control for outputting the data to the communication device according to the second wireless communication method, based on the information; and
in a case where an error occurs during the first output control, second output control for outputting the data to the server apparatus according to the second wireless communication method, based on the information.

14. The communication method according to claim 10, wherein the outputting step includes outputting the data to the output destination, by using push-type communication according to the second wireless communication method.

15. The communication method according to claim 10, wherein an NFC communication protocol is operative in wireless communication according to the first wireless communication method.

16. The communication method according to claim 15, wherein the wireless communication unit serves as a target in the NFC communication protocol, and
the receiving step receives the request and the information from the communication device serving as an initiator in the NFC communication protocol via the wireless communication unit.

17. The communication method according to claim 10, wherein in a case where the receiving step receives a request for switching over a wireless communication method from the first communication method to the second communication method from the communication device using the first wireless communication method, the first communication method is switched over to the second communication method so that the data is outputted at the outputting step, using the second communication method.

18. The communication method according to claim 10, wherein the predetermined processing contains reading an original by a reading apparatus, and
at the outputting step, image obtained by reading the original reading by the reading apparatus is outputted as the data.

19. A non-transitory computer readable storage which stores a computer program for executing
wirelessly communicating with a communication device according to each of a first wireless communication method and a second wireless communication method that has a communicable range wider than that in the first wireless communication method;
receiving a request for executing predetermined processing and information for performing wireless communication according to the second wireless communication method with an output destination of data obtained by executing the predetermined processing, by performing wireless communication according to the first wireless communication with the communication device;
executing the predetermined processing upon receiving the request; and
outputting the data obtained by executing the predetermined processing to the output destination, by performing wireless communication according to the second wireless communication method with the output destination, based on the received information.
